(19) United States
(12) Patent Application Publication
(10) Pub. No.: US 2016/0075913 A1
(43) Pub. Date: Mar. 17, 2016

(54) SOLUTION OF AROMATIC POLYAMIDE FOR PRODUCING DISPLAY ELEMENT, OPTICAL ELEMENT, ILLUMINATION ELEMENT OR SENSOR ELEMENT

(71) Applicants: AKRON POLYMER SYSTEMS, INC., Akron, OH (US); SUMITOMO BAKELITE COMPANY LIMITED, Shinagawa-ku (JP)

(72) Inventors: Limin Sun, Copley, OH (US); Jiaokai Jing, Uniontown, OH (US); Dong Zhang, Uniontown, OH (US); Frank W. Harris, Boca Raton, FL (US); Ritsuya Kawasaki, Kobe-shi (JP); Toshihiko Katayama, Nishinomiya-shi (JP); Jun Okada, Kobe-shi (JP); Hideo Umeda, Kobe-shi (JP)

(73) Assignees: AKRON POLYMER SYSTEMS, INC., Akron, OH (US); SUMITOMO BAKELITE COMPANY LIMITED, Shinagawa-ku (JP)

(21) Appl. No.: 14/848,995

(22) Filed: Sep. 9, 2015

Related U.S. Application Data
(60) Provisional application No. 62/048,985, filed on Sep. 11, 2014.

(51) Int. Cl. C09D 177/10; B05D 3/00

(52) U.S. Cl. CPC C09D 177/10; B05D 3/007

(57) ABSTRACT

The present disclosure, in one aspect, relates to a polyamide solution which can suppress the yellowness. The present disclosure, in one or a plurality of embodiments, relates to a polyamide solution comprising an aromatic polyamide and a solvent, the aromatic polyamide comprising a constitutional unit having one or more free carboxyl groups and having an aromatic ring structure and an alicyclic structure in the main chain. Further, the present disclosure, in one aspect, relates to a laminated composite material, comprising a glass plate and a polyamide resin layer; the polyamide resin layer laminated onto one surface of the glass plate, the polyamide resin layer having yellowness (JIS K7373) of 2.4 or less; and the polyamide resin layer obtained by applying the solution onto the glass plate.

### CROSS-REFERENCE TO RELATED APPLICATION

The disclosure is based upon and claims priority from U.S. Provisional Application Ser. No. 62/048,985, filed on Sep. 11, 2014, the disclosure of which is hereby incorporated by reference herein in its entirety.

### TECHNICAL FIELD

This disclosure, in one aspect, relates to a solution of an aromatic polyamide. This disclosure, in another aspect, relates to a laminated composite material including a glass plate and a polyamide resin layer, wherein the polyamide resin layer is laminated onto one surface of the glass plate, and the polyamide resin layer is obtained by applying the solution of polyamide onto the glass plate. This disclosure, in another aspect, relates to a process for manufacturing a display element, an optical element, an illumination element or a sensor element, including the step of forming a polyamide film using the solution of polyamide.

### BACKGROUND

As transparency is required for display elements, glass substrates using glass plates have been used as substrates for the elements (JP10311987 (A)). However, for display elements using glass substrates, problems such as being heavy in weight, breakable and unbendable have been pointed out at times. Thus, use of a transparent resin film instead of a glass substrate has been proposed.

For example, polycarbonates, which have high transparency, are known as transparent resins for use in optical applications. However, their heat resistance and mechanical strength may not be sufficient to be used for manufacturing display elements. On the other hand, examples of heat resistant resins include polyimides. However, typical polyimides are brown-colored, and thus they may not be suitable for use in optical applications. As polyimides with transparency, those having a ring structure are known. However, the problem with such polyimides is that they have poor heat resistance.

For polyamide films for use in optical applications, WO 2004/039863 and JP 2008260266(A) each discloses an aromatic polyamide having diamine including a trifluoro group, which provides both high stiffness and heat resistance.

WO 2012/129422 discloses a transparent polyamide film with thermal stability and dimension stability. This transparent film is manufactured by casting a solution of aromatic polyamide and curing at a high temperature. The document discloses that the cured film has a transmittance of more than 80% over a range of 400 to 750 nm, a coefficient of thermal expansion (CTE) of less than 20 ppm/° C., and shows favorable solvent resistance. And the document discloses that the film can be used as a flexible substrate for a microelectronic device.

### SUMMARY

The present disclosure, in one aspect, relates to a polyamide solution comprising an aromatic polyamide and a solvent, wherein the aromatic polyamide comprises a constitutional unit having one or more free carboxyl groups and has an aromatic ring structure and an alicyclic structure in the main chain.

Further, the present disclosure, in one aspect, relates to a laminated composite material, comprising a glass plate and a polyamide resin layer; wherein the polyamide resin layer is laminated onto one surface of the glass plate; wherein the polyamide resin layer has yellowness (JIS K7373) of 2.4 or less; and wherein the polyamide resin layer is obtained by applying the solution onto the glass plate.

Further, the present disclosure, in another aspect, relates to a process for manufacturing a display element, an optical element, an illumination element, or sensor element, including the step of forming the display element, the optical element, the illumination element or the sensor element on a surface of the polyamide resin layer of the laminated composite material, wherein the surface is not opposed to the glass plate. Further, this disclosure, in another aspect, relates to a display element, an optical element, an illumination element or a sensor element manufactured through the process.

### BRIEF DESCRIPTION OF DRAWINGS

FIG. 1 is a flow chart for explaining a method for manufacturing an OLED element or a sensor element according to one embodiment.

FIG. 2 is a flow chart for explaining a method for manufacturing an OLED element or a sensor element according to one embodiment.

FIG. 3 is a flow chart for explaining a method for manufacturing an OLED element or a sensor element according to one embodiment.

FIG. 4 is a schematic cross-sectional view showing a configuration of an organic EL element 1 according to one embodiment.

FIG. 5 is a schematic cross-sectional view showing a sensor element 10 according to one embodiment.

### DETAILED DESCRIPTION

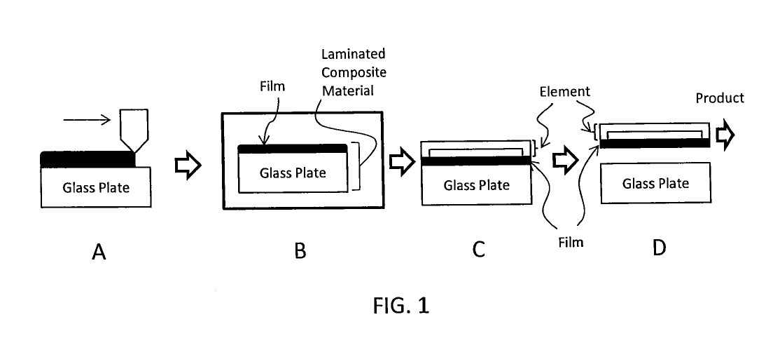

A display element, an optical element, or an illumination element such as an organic electro-luminescence (OEL) or organic light-emitting diode (OLED) is often produced by the method as described in FIG. 1. Briefly, a polymer solution (varnish) is applied or casted onto a glass base or a silicon wafer base (step A), the applied polymer solution is cured to form a film (step B), an element such as OLED is formed on the film (step C), and then, the element such as OLED (product) is de-bonded from the base (step D). These days, polyimide film is used as the film in the method in FIG. 1.

A sensor element used for an input device such as an image pickup device also is manufactured often by the process described in FIG. 1. Briefly, a polymer solution (varnish) is applied onto a base (glass or silicon wafer) (step A), the applied polymer solution is cured to form a film (step B), a photoelectric conversion element and its driver element are formed on the film (step C), and then, the sensor element is de-bonded from the base (step D).

In the step B of manufacturing the display element, the optical element, the illumination element or the sensor element as illustrated in FIG. 1, that is, when the varnish (solution of polyamide) applied onto a glass base is dried and/or cured to form a film, there has been found a problem that the film is colored yellow. The yellowness of the film may negatively affect the product (for example a display element and a display) quality. Therefore, the present disclosure, in one or a plurality of embodiments, relates to a polyamide solution which can suppress the yellowness.

The present disclosure is based on a knowledge that the yellowness of the film in the step B is suppressed by the polyamide having an alicyclic structure in addition to an aromatic structure in the main chain. That is, the present disclosure, in one or a plurality of embodiments, relates to a polyamide solution (hereinafter, referred also as the polyamide solution according to the present disclosure) comprising an aromatic polyamide and a solvent, wherein the aromatic polyamide comprises a constitutional unit having one or more free carboxyl groups and has an aromatic ring structure and an alicyclic structure in the main chain. In one or a plurality of embodiments, the polyamide solution according to the present disclosure can suppress the yellowness of a cast film manufactured by casting a polyamide solution on a glass plate. Therefore, the present disclosure, in one or a plurality of embodiments, relates to a polyimide solution which can suppress the yellowness. In one or a plurality of embodiments, the polyamide solution according to the present disclosure may improve the quality of a display element, a optical element, an illumination element or sensor element.

In one or a plurality of embodiments, the term “a cast film manufactured by casting a polyamide solution on a glass plate” refers to a film obtained by applying the polyamide solution according to the present disclosure onto a flat glass base, and drying, and if necessary curing, the applied solution. In one or a plurality of embodiments, the cast film refers to a film manufactured by the film formation method disclosed in Examples. In one or a plurality of non-limiting embodiments, thickness of the cast film is 7 μm to 12 μm, 9 μm to 12 μm, 9 μm to 11 μm, about 10 μm or 10 μm.

[Yellowness (Yellow Index)]

In this disclosure, yellowness of a film refers to the index which shows that the more the figure is large, there is yellow coloring the more. The yellowness of each polyamide film is measured according to JIS K7373, and simply measured by spectrophotometer.

In one or a plurality of embodiments, regarding the polyamide solution according to the present disclosure, in terms of being used for the sensor element used in an input device, the cast film (thickness: 9 to 12 μm) formed by casting the polyamide solution on a glass plate has preferably a yellowness of 2.4 or less, 2.3 or less, 2.2 or less, 2.1 or less. In one or a plurality of embodiments, lower limit of the yellowness, but is not limited to, is 0.1 or more.

[Total Light Transmittance]

In one or a plurality of embodiments, as to the polyamide solution used in the production method according to the present disclosure, in terms of being used for the sensor element used in an input device, the cast film formed by casting the polyamide solution on a glass plate has, in one or a plurality of embodiments, a total light transmittance at 400 nm of 70% or more, 75% or more, or 80% or more in terms of allowing the laminated composite material to be used suitably in the sensor element used in an input device.

[Polyimide]

The polyamide of the polyamide solution according to the present disclosure is an aromatic polyamide (hereinafter, referred also as polyamide), wherein the aromatic polyamide comprises a constitutional unit having one or more free carboxyl groups and has an aromatic ring structure and an alicyclic structure in the main chain. The term “aromatic polyamide” as used herein refers to a polyamide which has an aromatic ring structure in the main chain.

[A Constitutional Unit Having Free Carboxyl Groups]

In one or a plurality of embodiments, regarding the polyamide of the polyamide solution according to the present disclosure, the ratio of a constitutional unit having free carboxyl groups, in terms of the solvent resistance, is 0.01 mol % or more and 30 mol % or less, 0.1 mol % or more and 20 mol % or less, 1 mol % or more and 10 mol % or less, or 3 mole % and more or 7 mole % or less of the total amount of constitutional units.

Similarly, in one or a plurality of embodiments, regarding the polyamide solution according to the present disclosure, the ratio of monomer components having free carboxyl groups, in terms of improving of the solvent resistance, is 0.005 mol % or more and 15 mol % or less, 0.05 mol % or more and 10 mol % or less, 0.5 mol % or more and 5 mol % or less, or 1.5 mole % and more or 3.5 mole % or less of the total amount of monomer components used for synthesis of the polyamide.

[A Constitutional Unit Having an Alicyclic Structure]

In one or a plurality of embodiments, regarding the polyamide of the polyamide solution according to the present disclosure, the ratio of a constitutional unit having an alicyclic structure, in terms of suppressing of yellowness of the cast film, is preferably more than 3 mol %, more than 4 mol %, more than 6 mol %, more than 8 mol %, or more than 10 mol % of the total amount of constitutional units.

Similarly, the ratio of a constitutional unit having an alicyclic structure is preferably less than 60 mol %, less than 50 mol %, less than 45 mol %, less than 40 mol %, or less than 35 mol %. Then In one or a plurality of embodiments, regarding the polyamide of the polyamide solution according to the present disclosure, the ratio of a constitutional unit having an alicyclic structure, in terms of suppressing of yellowness of the cast film, is preferably 3 mol % or more and 60 mol % or less, 4 mol % or more and 50 mol % or less, 6 mol % or more and 45 mol % or less, 8 mol % or more and 40 mol % or less, or 10 mol % or more and 35 mol % or less of the total amount of constitutional units.

Similarly, in one or a plurality of embodiments, regarding the polyamide of the polyamide solution according to the present disclosure, the ratio of monomer components which can introduce an alicyclic structure in the main chain, in terms of suppressing of yellowness of the cast film, is preferably more than 1.5 mol %, more than 2 mol %, more than 3 mol %, more than 4 mol %, or more than 5 mol % of the total amount of monomer components used for synthesis of the polyamide. Similarly, the ratio of monomer components which can introduce an alicyclic structure in main the chain is preferably less than 30 mol %, less than 25 mol %, less than 22.5 mol %, less than 20 mol %, or less than 17.5 mol %. Then in one or a plurality of embodiments, regarding the polyamide of the polyamide solution according to the present disclosure, the ratio of monomer components which can introduce an alicyclic structure in the main chain, in terms of suppressing of yellowness of the cast film, is preferably 1.5 mol % or more and 30 mol % or less, 2 mol % or more and 25 mol % or less, 3 mol % or more and 25 mol % or less, 3 mol % or more and 22.5 mol % or less, 4 mol % or more and 20 mol % or less, or 5 mol % or more and 17.5 mol % less of the total amount of monomer components used for synthesis of the polyamide.

In one or plurality of embodiments, in terms of suppressing of yellowness of the cast film, the aromatic polyamide of the solution according to this disclosure has repeat units of general formulas from (I) to (IV):

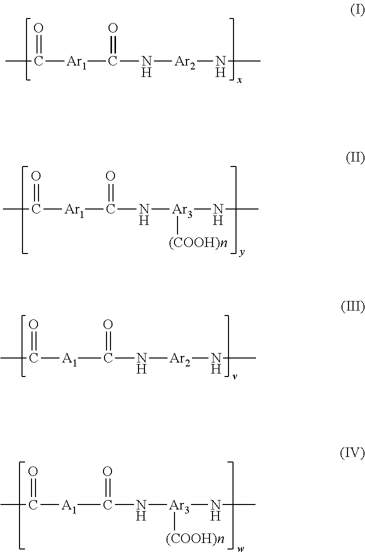

wherein x represents mole % of the constitutional unit (I), y represents mole % of the constitutional unit (II), v represents mole % of the constitutional unit (III), and w represents mole % of the constitutional unit (IV), wherein x+v is 70 to 99.99 mole %;

wherein y+w is 30 to 0.01 mole %;

wherein x+y is 96 to 50 mole %;

wherein v+w is 4 to 50 mole %;

wherein n=1 to 4;

In the formulae (I) and (II), An is selected from the group consisting of:

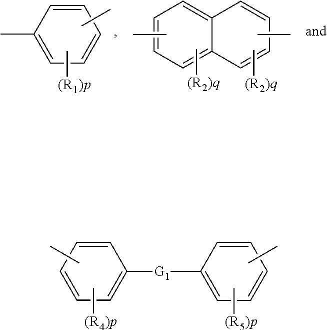

wherein p=4, q=3, and wherein R₁, R₂, R₃, R₄, R₅ are selected from the group comprising hydrogen, halogen (fluorine, chlorine, bromine, and iodine), alkyl, substituted alkyl such as halogenated alkyl, nitro, cyano, thioalkyl, alkoxy, substituted alkoxy such as halogenated alkoxy, aryl, or substituted aryl such as halogenated aryl, alkyl ester, and substituted alkyl ester such as halogenated alkyl ester, and combinations thereof. It is to be understood that each R₁ can be different, each R₂ can be different, each R₃ can be different, each R₄ can be different, and each R₅ can be different. G₁ is selected from a group comprising a covalent bond; a CH₂ group; a C(CH₃)₂ group; a C(CF₃)₂ group; a C(CX₃)₂ group, wherein X is a halogen (fluorine, chlorine, bromine, and iodine); a CO group; an O atom; a S atom; a SO₂ group; a Si(CH₃)₂ group; 9,9-fluorene group; substituted 9,9-fluorene group; and an OZO group, wherein Z is an aryl group or substituted aryl group, such as phenyl group, biphenyl group, perfluorobiphenyl group, 9,9-bisphenylfluorene group, and substituted 9,9-bisphenylfluorene group;

In the formulae (III) and (IV), A₁ is selected from the group consisting of:

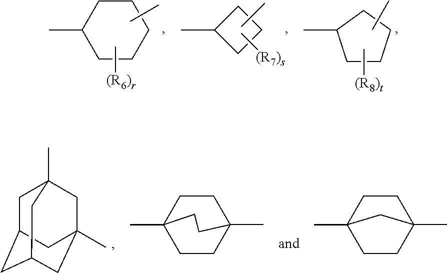

wherein r=10, s=6, t=8 and wherein R₆, R₇, R₈ are selected from the group comprising hydrogen, halogen (fluorine, chlorine, bromine, and iodine), alkyl, substituted alkyl such as halogenated alkyl, nitro, cyano, thioalkyl, alkoxy, substituted alkoxy such as halogenated alkoxy, aryl, or substituted aryl such as halogenated aryl, alkyl ester and substituted alkyl ester such as halogenated alkyl ester, and combinations thereof. It is to be understood that each R₁ can be different. When A₁ may have geometrical isomers, the geometrical isomers may be sis-form, trans-form, or mixture of those, in terms of reactivity, preferably be comprising of trans-form, more preferably be consisting of more than 50% trans-form, farther preferably be consisting of more than 60%, more than 70%, more than 80%, more than 90%, more than 95%, or more than 99%.

In the formula (I) and (III), Ar₂ is selected from the group consisting of:

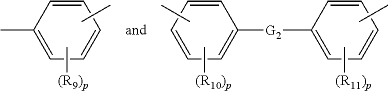

wherein p=4, wherein R₉, R₁₀, R₁₁ are selected from the group comprising hydrogen, halogen (fluorine, chlorine, bromine, and iodine), alkyl, substituted alkyl such as halogenated alkyl, nitro, cyano, thioalkyl, alkoxy, substituted alkoxy such as halogenated alkoxy, aryl, substituted aryl such as halogenated aryl, alkyl ester, and substituted alkyl ester such as halogenated alkyl ester, and combinations thereof. It is to be understood that each R₆ can be different, each R₇ can be different, and each R₈ can be different. G₂ is selected from a group comprising a covalent bond; a CH₂ group; a C(CH₃)₂ group; a C(CF₃)₂ group; a C(CX₃)₂ group, wherein X is a halogen; a CO group; an O atom; a S atom; a SO₂ group; a Si(CH₃)₂ group; 9,9-fluorene group; substituted 9,9-fluorene group; and an OZO group, wherein Z is an aryl group or substituted aryl group, such as phenyl group, biphenyl group, perfluorobiphenyl group, 9,9-bisphenylfluorene group, and substituted 9,9-bisphenylflorene group;

In the formula (II) and (IV), Ara is selected from the group consisting of:

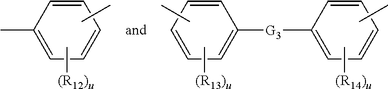

wherein u=0 to 3, wherein R₁₂, R₁₃, R₁₄ are selected from the group comprising hydrogen, halogen (fluorine, chlorine, bromine, and iodine), alkyl, substituted alkyl such as halogenated alkyl, nitro, cyano, thioalkyl, alkoxy, substituted alkoxy such as halogenated alkoxy, aryl, substituted aryl such as halogenated aryl, alkyl ester, and substituted alkyl ester such as halogenated alkyl ester, and combinations thereof. It is to be understood that each Re can be different, each R₁₀ can be different, and each R₁₁ can be different. G₃ is selected from a group comprising a covalent bond; a CH₂ group; a C(CH₃)₂ group; a C(CF₃)₂ group; a C(CX₃)₂ group, wherein X is a halogen; a CO group; an O atom; a S atom; a SO₂ group; a Si(CH₃)₂ group; 9,9-fluorene group; substituted 9,9-fluorene group; and an OZO group, wherein Z is an aryl group or substituted aryl group, such as phenyl group, biphenyl group, perfluorobiphenyl group, 9,9-bisphenylfluorene group, and substituted 9,9-bisphenylfluorene group.

In one or a plurality of embodiments, mol % (y+w) of constitutional units of (II) and (IV), in terms of improving of the solvent resistance, is 0.01 mol % or more and 30 mol % or less, 0.1 mol % or more and 20 mol % or less, 1 mol % or more and 10 mol % or less, or 3 mol % or more and 7 mol % or less of the total amount of constitutional units (x+y+v+w).

In one or a plurality of embodiments, mol % (v+w) of constitutional units of (III) and (IV), in terms of improving of suppressing of the yellowness, is preferably more than 3 mol %, more than 4 mol %, more than 6 mol %, more than 8 mol %, or more than 10 mol % of the total amount of constitutional units (x+y+v+w). Similarly, mol % (v+w) of constitutional units of (III) and (IV) is 3 mol % or more and 60 mol % or less, 4 mol % or more and 50 mol % or less, 6 mol % or more and 45 mol % or less, 8 mol % or more and 40 mol % or less, or 10 mol % or more and 35 mol % or less of the total amount of constitutional units (x+y+v+w).

In one or plurality of embodiments, the aromatic polyamide according this disclosure contains multiple repeat units with the structures (I) and (II) where Ar₁, Ar₂, and Ar₃ are the same or different. In another one or plurality of embodiments, the aromatic polyamide according this disclosure contains multiple repeat units with the structures (III) and (IV) where A₁, Ar₂, and Ar₃ are the same or different.

In one or plurality of embodiments, halogen according to this disclosure may be fluorine, chlorine, bromine, and iodine.

[Manufacture Method of the Polyamide]

In one or plurality of embodiments, in terms of using a film in a display element, an optical element, an illumination element or sensor element and suppressing yellowness of a cast film, the solution of polyamide according to this disclosure is one obtained or may be obtained through a manufacturing process including the following steps. However, the solution of polyamide according to this disclosure is not limited to the one manufactured through the following manufacturing process.

a) dissolving at least one aromatic diamine in a solvent;

b) reacting at least one aromatic diamine mixture with at least one aromatic diacid dichloride, wherein hydrochloric acid and a polyamide solution is generated; and

c) removing the free hydrochloric acid by reaction with a trapping reagent;

In one or a plurality of embodiments of the method for manufacturing a polyamide solution of the present disclosure, the aromatic diacid dichloride is an aromatic diacid dichloride, and includes those shown in the following general structures:

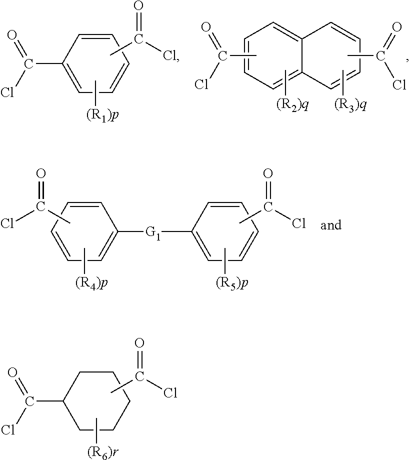

wherein p=4, q=3, r=10 and wherein R₁, R₂, R₃, R₄, R₅, R₆ are selected from the group consisting of hydrogen, halogen (fluorine, chlorine, bromine, and iodine), alkyl, substituted alkyl such as halogenated alkyl, nitro, cyano, thioalkyl, alkoxy, substituted alkoxy such as a halogenated alkoxy, aryl, or substituted aryl such as halogenated aryl, alkyl ester and substituted alkyl ester such as halogenated alkyl ester, and combinations thereof. It is to be understood that each R₁ can be different, each R₂ can be different, each R₃ can be different, each R₄ can be different, and each R₅ can be different. G₁ is selected from the group consisting of a covalent bond; a CH₂ group; a C(CH₃)₂ group; a C(CF₃)₂ group; a C(CX₃)₂ group, wherein X is a halogen; a CO group; an O atom; a S atom; a SO₂ group; a Si(CH₃)₂ group; 9,9-fluorene group; substituted 9,9-fluorene group; and an OZO group, where in Z is an aryl group or substituted aryl group, such as phenyl group, biphenyl group, perfluorobiphenyl group, 9,9-bisphenylfluorene group, and substituted 9,9-bisphenylfluorene group.

In one or a plurality of embodiments, from the viewpoint of using the film in a display element, an optical element, an illumination element or a sensor element, examples of the aromatic diacid dichloride used in the method for manufacturing the polyamide solution according the present disclosure include the following.

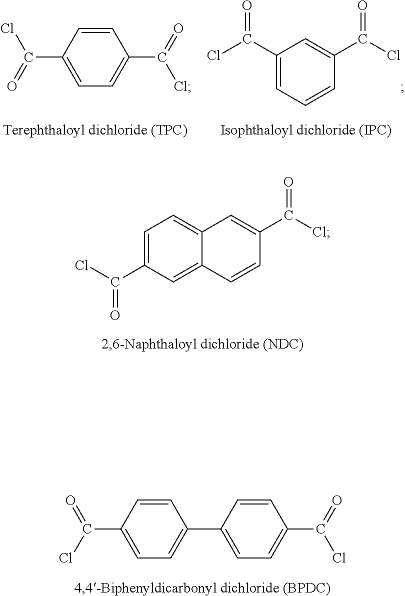 [SMILES: O=C(Cl)c1ccc(C(=O)Cl)cc1 ; O=C(Cl)c1cccc(C(=O)Cl)c1 ; O=C(Cl)c1ccc2cc(C(=O)Cl)ccc2c1 ; O=C(Cl)c1ccc(-c2ccc(C(=O)Cl)cc2)cc1]

Examples of the diacid dichloride used in the method for manufacturing the polyamide solution, in the terms of suppressing of the yellowness of the cast film, preferably include alicyclic diacid dichloride which can introduce an alicyclic structure in the main chain with above aromatic acid, specifically include following alicyclic diacid.

HTPC: Hexahydro Terephthaloyl dichloride (1,4-Cyclohexanedicarboxylic acid dichloride);

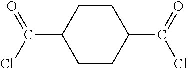 [SMILES: O=C(Cl)C1CCC(C(=O)Cl)CC1]

In one or a plurality of embodiments of the method for manufacturing a polyamide solution of the present disclosure, the aromatic diacid diamine includes those shown in the following general structures:

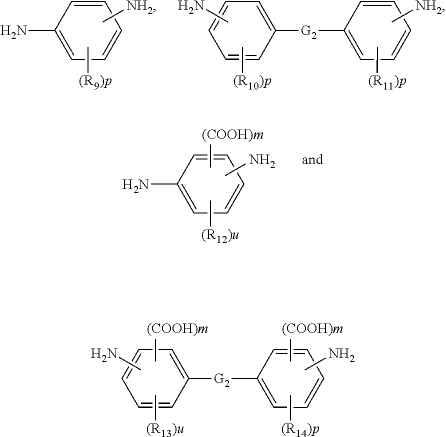

wherein p=4, m=1 to 4, and u=0 to 3, wherein R₉, R₁₀, R₁₁, R₁₂, R₁₃, R₁₄ are selected from the group consisting of hydrogen, halogen (fluorine, chlorine, bromine, and iodine), alkyl, substituted alkyl such as halogenated alkyl, nitro, cyano, thioalkyl, alkoxy, substituted alkoxy such as a halogenated alkoxy, aryl, substituted aryl such as halogenated aryl, alkyl ester, and substituted alkyl ester such as halogenated alkyl ester, and combinations thereof. It is to be understood that each R₆ can be different, each R₇ can be different, each R₈ can be different, each R₉ can be different, each R₁₀ can be different, and each R₁₁ can be different. G₂ and G₃ are selected from the group consisting of a covalent bond; a CH₂ group; a C(CH₃)₂ group; a C(CF₃)₂ group; a C(CX₃)₂ group, wherein X is a halogen; a CO group; an O atom; a S atom; a SO₂ group; a Si(CH₃)₂ group; 9,9-fluorene group; substituted 9,9-fluorene; and an OZO group, wherein Z is an aryl group or substituted aryl group, such as phenyl group, biphenyl group, perfluorobiphenyl group, 9,9-bisphenylfluorene group, and substituted 9,9-bisphenylfluorene.

In one or plurality of embodiments, in terms of using the film in a display element, an optical element, an illumination element or a sensor element and suppressing yellowness, examples of the aromatic diamine used in the process for manufacturing the solution of polyamide according this disclosure include the following.

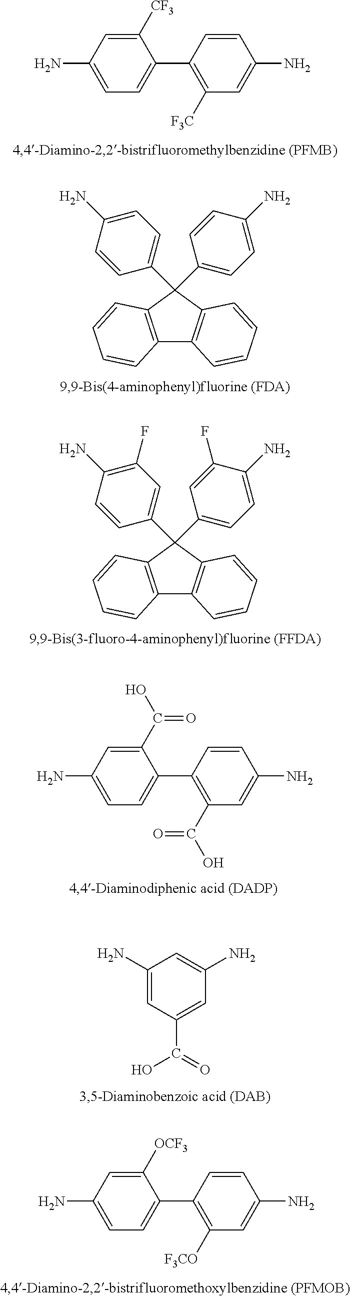 [SMILES: Nc1ccc(-c2ccc(N)cc2C(F)(F)F)c(C(F)(F)F)c1 ; Nc1ccc(C2(c3ccc(N)cc3)c3ccccc3-c3ccccc32)cc1 ; Nc1ccc(C2(c3ccc(N)c(F)c3)c3ccccc3-c3ccccc32)cc1F ; Nc1ccc(-c2ccc(N)cc2C(=O)O)c(C(=O)O)c1 ; Nc1cc(N)cc(C(=O)O)c1 ; Nc1ccc(-c2ccc(N)cc2OC(F)(F)F)c(OC(F)(F)F)c1]

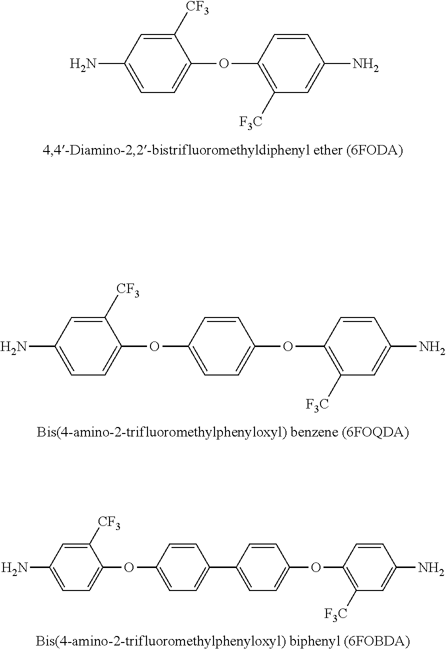 [SMILES: Nc1ccc(Oc2ccc(N)cc2C(F)(F)F)c(C(F)(F)F)c1 ; Nc1ccc(Oc2ccc(Oc3ccc(N)cc3C(F)(F)F)cc2)c(C(F)(F)F)c1 ; Nc1ccc(Oc2ccc(-c3ccc(Oc4ccc(N)cc4C(F)(F)F)cc3)cc2)c(C(F)(F)F)c1]

In one or a plurality of embodiments of the method for manufacturing a polyamide solution of the present disclosure, a polyamide is produced via a condensation polymerization in a solvent, where the hydrochloric acid generated in the reaction is trapped by a reagent like propylene oxide (PrO).

In one or a plurality of embodiments of the present disclosure, from the viewpoint of use of the polyamide solution in the method for manufacturing a display element, an optical element, an illumination element or a sensor element, the reaction of hydrochloric acid with the trapping reagent yields a volatile product.

In one or a plurality of embodiments of the present disclosure, from the viewpoint of use of the polyamide solution in the method for manufacturing a display element, an optical element, an illumination element or a sensor element, the trapping reagent is propylene oxide (PrO). In one or a plurality of embodiments of the present disclosure, the reagent is added to the mixture before or during the reacting step (b). Adding the reagent before or during the reaction step (b) can reduce degree of viscosity and generation of lumps in the mixture after the reaction step (b), and therefore, can improve productivity of the polyamide solution. These effects are significant specifically when the reagent is organic reagent, such as propylene oxide.

In one or a plurality of embodiments of the present disclosure, from the viewpoint of enhancement of heat resistance property of the polyamide film, the method further comprises the step of end-capping of one or both of terminal —COOH group and terminal —NH₂ group of the polyamide. The terminal of the polyamide can be end-capped by the reaction of polymerized polyamide with benzoyl chloride when the terminal of polyamide is —NH₂, or reaction of polymerized polyamide with aniline when the terminal of polyamide is —COOH. However, the method of end-capping is not limited to this method.

In one or a plurality of embodiments of the present disclosure, from the viewpoint of use of the polyamide solution in the method for manufacturing a display element, an optical element, an illumination element or a sensor element, the polyamide is first isolated from the polyamide solution by precipitation and re-dissolution into solvent. The precipitation can be carried out by a typical method. In one or a plurality of embodiments, by adding the polyamide to methanol, ethanol, isopropyl alcohol or the like, it is precipitated, cleaned, and re-dissolved in the solvent, for example.

In one or a plurality of embodiments of the present disclosure, from the viewpoint of use of the polyamide solution in the method for manufacturing a display element, an optical element, an illumination element or a sensor element, the polyamide solution is produced in the absence of inorganic salt.

In one or plurality of embodiments, in terms of using a film in a display element, an optical element, an illumination element or a sensor element, and suppressing of yellowness, the aromatic polyamide according this disclosure has a flexible backbone. In one or plurality of embodiments, the term “the aromatic polyamide having a flexible backbone” as used herein means that an aromatic group in the polyamide main chain has repeat units that are bonded to a position other than the para-position, or refers to polyamide synthesized using aromatic monomer components having a flexible backbone.

[Average Molecular Weight of Polyamide]

In one or plurality of embodiments, in terms of using a film in a display element, an optical element, or an illumination element, it is preferable that the aromatic polyamide of the solution of polyamide according to this disclosure has a number-average molecular weight (Mn) of 6.0×10⁴ or more, 6.5×10⁴ or more, 7.0×10⁴ or more, 7.5×10⁴ or more, or 8.0×10⁴ or more. Similarly, in one or plurality of embodiments, the number-average molecular weight is 1.0×10⁶ or less, 8.0×10⁵ or less, 6.0×10⁵ or less, or 4.0×10⁵ or less.

In this disclosure, the number-average molecular weight (Mn) and the weight-average molecular weight (Mw) of the polyamide are measured by Gel Permeation Chromatography, and more specifically, they are measured by a method described in Examples.

In one or plurality of embodiments, in terms of using a film in a display element, an optical element, an illumination element or a sensor element, it is preferable that the molecular weight distribution (=Mw/Mn) of the aromatic polyamide of the solution of polyamide according to this disclosure is 5.0 or less, 4.0 or less, 3.0 or less, 2.8 or less, 2.6 or less, or 2.4 or less. Similarly, in one or plurality of embodiments, the molecular weight distribution of the aromatic polyamide is 2.0 or more.

In one or plurality of embodiments, in terms of using a film in a display element, an optical element, an illumination element or a sensor element, the solution of polyamide according to this disclosure is one undergone re-precipitation after the synthesis of the polyamide.

In one or plurality of embodiments of this disclosure, one or both of terminal —COOH group and terminal —NH₂ group of the aromatic polyamide are end-capped. The end-capping of the terminal is preferable from the point of enhancement of heat resistance property of the polyamide film. The terminal of the polyamide can be end-capped by the reaction of polymerized polyamide with benzoyl chloride when the terminal of polyamide is —NH₂, or reaction of polymerized polyamide with aniline when the terminal of polyamide is —COOH. However, the method of end-capping is not limited to this method.

[Solvent]

In one or plurality of embodiments of this disclosure, in terms of enhancement of solubility of the polyamide to the solvent, the solvent is a polar solvent or a mixed solvent comprising one or more polar solvents. In one or plurality of embodiments of this disclosure, in terms of enhancement of solubility of the polyamide to the solvent and enhancement of the adhesion between polyamide film and the base, the solvent is methanol, ethanol, propanol, isopropanol (IPA), butanol, acetone, methyl ethyl ketone (MEK), methyl isobutyl ketone (MIBK), toluene, cresol, xylene, propylene glycol monomethyl ether acetate (PGMEA), N,N-dimethylacetamide (DMAc), N-methyl-2-pyrrolidinone (NMP), dimethylsulfoxide (DMSO), butyl cellosolve, γ-butyrolactone, α-methyl-γ-butyrolactone, methyl cellosolve, ethyl cellosolve, ethylene glycol monobutyl ether, diethylene glycol monobutyl ether, N,N-dimethylformamide (DMF), 3-methoxy-N,N-dimethylpropionamide, 3-butoxy-N,N-dimethylpropanamide, 1-ethyl-2-pyrrolidone, N,N-dimethylpropionamide, N,N-dimethylbutyramide, N,N-diethylacetamide, N,N-diethylpropionamide, 1-methyl-2-piperidinone, propylene carbonate, a combination thereof, or a mixed solvent comprising at least one of the solvents.

[Polyamide Content]

In one or plurality of embodiments, in terms of using a film in a display element, an optical element, an illumination element or a sensor element, the aromatic polyamide content of the solution of polyamide according to this disclosure is 2 wt % or more, 3 wt % or more, or 5 wt % or more. Similarly, the aromatic polyamide content is 30 wt % or less, 20 wt % or less, or 15 wt % or less.

In one or a plurality of embodiments, the polyamide solution according to the present disclosure is a polyamide solution for use in a method for manufacturing a display element, an optical element, an illumination element or a sensor element, including the steps a) to c).

a) applying a solution of an aromatic polyamide onto a base;

b) forming a polyamide film on the base after the applying step (a); and

c) forming the display element, the optical element, the illumination element, or a sensor element and its driver element, on the surface of polyamide film.

Here, the base or the surface of the base is composed of glass or silicon wafer. Further, in one or a plurality of embodiments, for the application in the step a), various methods for liquid phase film formation such as dye-coating, ink-jetting, spin-coating, bar-coating, roll-coating, wire bar coating, and dip-coating can be used.

[Laminated Composite Material]

The term “laminated composite material” as used herein refers to a material in which a glass plate and a polyamide resin layer are laminated. In one or a plurality of non-limiting embodiments, a glass plate and a polyamide resin layer being laminated indicates that the glass plate and the polyamide resin layer are laminated directly. Alternatively, in one or a plurality of non-limiting embodiments, it indicates that the glass plate and the polyamide resin layer are laminated via one or a plurality of layers. In the present disclosure, the organic resin of the organic resin layer is a polyamide resin. Therefore in one or a plurality of embodiments, the laminated composite material in the present disclosure includes a glass plate and a polyamide resin layer, i.e., a polyamide resin layer laminated on one surface of a glass plate.

In one or a plurality of non-limiting embodiments, the laminated composite material according to the present disclosure can be used in a method for manufacturing a display element, an optical element, an illumination element or a sensor element, such as the one illustrated in FIG. 1. Further, in one or a plurality of non-limiting embodiments, the laminated composite material according to the present disclosure can be used as a laminated composite material obtained in the step B of the manufacturing method illustrated in FIG. 1. Therefore, in one or a plurality of non-limiting embodiments, the laminated composite material according to the present disclosure is a laminated composite material to be used for a method for manufacturing a display element, an optical element, an illumination element or a sensor element, the method including forming a display element, an optical element or an illumination element, or a sensor element on a surface of the polyamide resin layer which is opposite to the surface facing the glass plate.

The laminated composite material according to the present disclosure may include additional organic resin layers and/or inorganic layers in addition to the polyamide resin layer. In one or a plurality of non-limiting embodiments, examples of additional organic resin layers include a flattened coat layer. Further, in one or a plurality of non-limiting embodiments, examples of inorganic layers include a gas barrier layer capable of suppressing permeation of water or oxygen and a buffer coat layer capable of suppressing migration of ions to a TFT element.

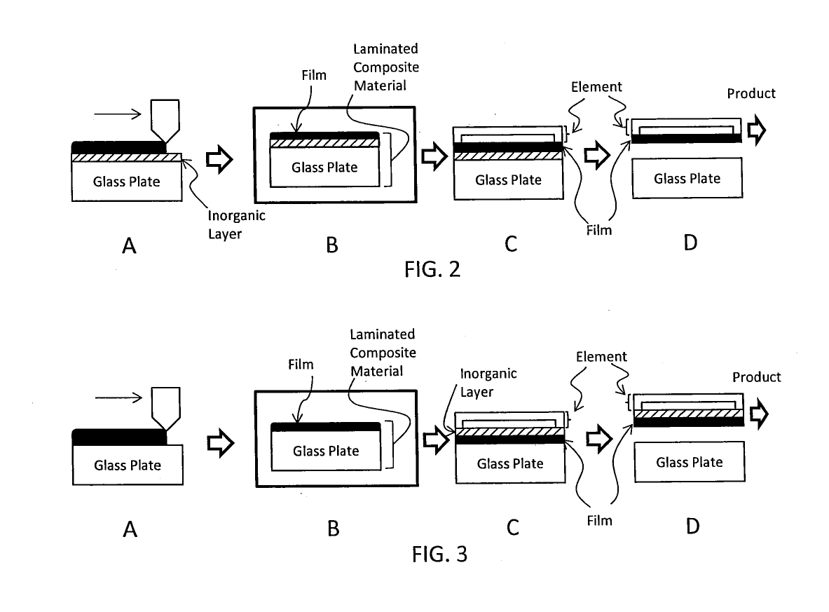

FIG. 2 shows one or a plurality of non-limiting embodiments where an inorganic layer is formed between the glass plate and the polyamide resin layer. An example of the inorganic layer in this embodiment is an amorphous Si layer formed on the glass plate. In the step A, polyamide vanish is applied onto the amorphous Si layer on the glass plate, which is dried and/or cured in the step B thereby a laminated composite material is formed. In the step C, a display element, an optical element or an illumination element, or a sensor element is/are formed on the polyamide resin layer (polyamide film) of the laminated composite material, and in the step D, the amorphous Si layer is irradiated with a laser, thereby the display element, the optical element, the illumination element or the sensor element as the product (including the polyamide resin layer) is de-bonded from the glass plate.

FIG. 3 shows one or a plurality of non-limiting embodiments where an inorganic layer is formed on the surface of a polyamide resin layer which is opposite to the surface facing the glass plate. An example of the inorganic layer in this embodiment is an inorganic barrier layer. In the step A, a polyamide vanish is applied onto a glass plate, which is dried and/or cured in the step B thereby forming a laminated composite material. At this time, a further inorganic layer is formed on the polyamide resin layer (polyamide film). In one or a plurality of non-limiting embodiments, the laminated composite material in the present disclosure may include the inorganic layer (FIG. 3, step C). On this inorganic layer, a display element, an optical element, an illumination element or sensor element is/are formed. In the step D, the polyamide resin layer is de-bonded so as to obtain a display element, an optical element, an illumination element or a sensor element as the product (including polyamide resin layer).

[Polyimide Resin Layer]

The polyamide resin of the polyamide resin layer of the laminated composite material according to the present disclosure can be formed using the polyamide solution according to the present disclosure.

[Thickness of Polyamide Resin Layer]

In one or a plurality of embodiments, from the viewpoint of using the film in a display element, an optical element, an illumination element or a sensor element and suppressing the development of cracks in the resin layer, the polyamide resin layer of the laminated composite material according to the present disclosure has a thickness of 500 μm or less, 200 μm or less, or 100 μm or less. Further, in one or a plurality of non-limiting embodiments, the polyamide resin layer has a thickness of 1 μm or more, 2 μm or more, or 3 μm or more, for example.

[Transmittance of Polyamide Resin Layer]

In one or a plurality of embodiments, the polyamide resin layer of the laminated composite material according to the present disclosure has a total light transmittance of 70% or more, 75% or more, or 80% or more from the viewpoint of allowing the laminated composite material to be used suitably in manufacturing a display element, an optical element, an illumination element or a sensor element.

[Glass Plate]

In one or a plurality of embodiments, from the viewpoint of using the film in a display element, an optical element, an illumination element or a sensor element, the material of the glass plate of the laminated composite material according to the present disclosure may be, for example, soda-lime glass, none-alkali glass or the like. In one or a plurality of embodiments, from the viewpoint of using the film in a display element, an optical element, an illumination element or a sensor element, the glass plate of the laminated composite material according the present disclosure has a thickness of 0.3 mm or more, 0.4 mm or more, or 0.5 mm or more. Further, in one or a plurality of embodiments, the glass plate has a thickness of 3 mm or less or 1 mm or less, for example.

[Method for Manufacturing Laminated Composite Material]

The laminated composite material according to the present disclosure can be manufactured by applying the polyamide solution according to the present disclosure onto a glass plate, and drying, and if necessary curing, the applied solution.

In one or a plurality of embodiments of the present disclosure, a method for manufacturing the laminated composite material of the present disclosure includes the steps of.

a) applying a solution of an aromatic polyamide onto a base (glass plate); and

b) heating the casted polyamide solution to form a polyamide film after the applying step (a).

In one or a plurality of embodiments of the present disclosure, from the viewpoint of suppression of curvature deformation (warpage) and/or enhancement of dimension stability, the heating is carried out under the temperature ranging from approximately +40° C. of the boiling point of the solvent to approximately +100° C. of the boiling point of the solvent, preferably from approximately +60° C. of the boiling point of the solvent to approximately +80° C. of the boiling point of the solvent, more preferably approximately +70° C. of the boiling point of the solvent. In one or a plurality of embodiments of the present disclosure, from the viewpoint of suppression of curvature deformation (warpage) and/or enhancement of dimension stability, the temperature of the heating in step (b) is between approximately 200° C. and approximately 250° C. In one or a plurality of embodiments of the present disclosure, from the viewpoint of suppression of curvature deformation (warpage) and/or enhancement of dimension stability, the time of the heating is more than approximately 1 minute and less than approximately 30 minutes.

The method for manufacturing the laminated composite material may include, following the step (b), a curing step (c) in which the polyamide film is cured. The curing temperature depends upon the capability of a heating device but is 220 to 420° C., 280 to 400° C., 330° C. to 370° C., 340° C. or more or 340 to 370° C. in one or a plurality of embodiments. Further, in one or a plurality of embodiments, the curing time is 5 to 300 minutes or 30 to 240 minutes.

[Method for Manufacturing Display Element, Optical Element or Illumination Element]

The present disclosure, in one aspect, relates to a method for manufacturing a display element, an optical element, or an illumination element, which includes the step of forming the display element, the optical element, or the illumination element on a surface of the organic resin layer of the laminated composite material according to the present disclosure, i.e., a surface opposite to the surface facing the glass plate. In one or a plurality of embodiments, the manufacturing method further includes the step of de-bonding the thus formed display element, the optical element, or the illumination element formed from the glass plate.

[Display Element, Optical Element, or Illumination Element]

The term “a display element, an optical element, or an illumination element” as used in the present disclosure refers to an element that constitutes a display (display device), an optical device, or an illumination device, and examples of such elements include an organic EL element, a liquid crystal element, and organic EL illumination. Further, the term also covers a component of such elements, such as a thin film transistor (TFT) element, a color filter element or the like. In one or a plurality of embodiments, the display element, the optical element or the illumination element according to the present disclosure may include a product manufactured by using the polyamide solution according to the present disclosure, and a product using a polyamide film according to this disclosure as a substrate for the display element, the optical element or the illumination element.

<Non-Limiting Embodiment of Organic EL Element>

Hereinafter, one embodiment of an organic EL element as one embodiment of the display element according to the present disclosure will be described with reference to the drawing.

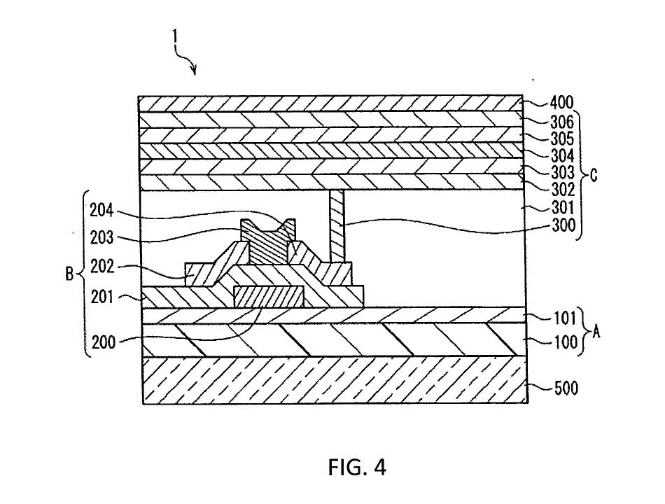

FIG. 4 is a schematic cross-sectional view showing an organic EL element 1 according to one embodiment. The organic EL element 1 includes a thin film transistor B formed on a substrate A and an organic EL layer C. Note that the organic EL element 1 is entirely covered with a sealing member 400. The organic EL element 1 may be separated from a base 500 or may include the base 500. Hereinafter, each component will be described in detail.

1. Substrate A

The substrate A includes a transparent resin substrate 100 and a gas barrier layer 101 formed on top of the transparent resin substrate 100. Here, the transparent resin substrate 100 is the polyamide film according to the present disclosure.

The transparent resin substrate 100 may have been annealed by heat. Annealing is effective in, for example, removing distortions and in improving the size stability against environmental changes.

The gas barrier layer 101 is a thin film made of SiOx, SiNx or the like, and is formed by a vacuum deposition method such as sputtering, CVD, vacuum deposition or the like. Generally, the gas barrier layer 101 has a thickness of, but is not limited to, about 10 nm to 100 nm. Here, the gas barrier layer 101 may be formed on the side of the transparent resin substrate 100 facing the gas barrier layer 101 in FIG. 4 or may be formed on the both sides.

2. Thin Film Transistor

The thin film transistor B includes a gate electrode 200, a gate insulating film 201, a source electrode 202, an active layer 203, and a drain electrode 204. The thin film transistor B is formed on the gas barrier layer 101.

The gate electrode 200, the source electrode 202, and the drain electrode 204 are transparent thin films made of indium tin oxide (ITO), indium zinc oxide (IZO), zinc oxide (ZnO), or the like. For example, sputtering, vapor deposition, ion plating or the like may be use to form these transparent thin films. Generally, these electrodes have a film thickness of, but is not limited to, about 50 nm to 200 nm.

The gate insulating film 201 is a transparent insulating thin film made of SiO₂, Al₂O₃ or the like, and is formed by sputtering, CVD, vacuum deposition, ion plating or the like. Generally, the gate insulating film 201 has a film thickness of, but is not limited to, about 10 nm to 1 μm.

The active layer 203 is a layer of, for example, single crystal silicon, low temperature polysilicon, amorphous silicon, or oxide semiconductor, and a material best suited to the active layer 203 is used as appropriate. The active layer is formed by sputtering or the like.

3. Organic EL Layer

The organic EL layer C includes a conductive connector 300, an insulative flattened layer 301, a lower electrode 302 as the anode of the organic EL element 1, a hole transport layer 303, a light-emitting layer 304, an electron transport layer 305, and an upper electrode 306 as the cathode of the organic EL element 1. The organic EL layer C is formed at least on the gas barrier layer 101 or on the thin film transistor B, and the lower electrode 302 and the drain electrode 204 of the thin film transistor B are connected to each other electrically through the connector 300. Instead, the lower electrode 302 and the source electrode 202 of the thin film transistor B may be connected to each other through the connector 300.

The lower electrode 302 is the anode of the organic EL element 1, and is a transparent thin film made of indium tin oxide (ITO), indium zinc oxide (IZO), zinc oxide (ZnO) or the like. ITO is preferred because, for example, high transparency, and high conductivity can be achieved.

For the hole transport layer 303, the light-emitting layer 304, and the electron transport layer 305, conventionally-known materials for organic EL elements can be used as is.

The upper electrode 306 is a film composed of a layer of lithium fluoride (LiF) having a film thickness of 5 nm to 20 nm and a layer of aluminum (Al) having a film thickness of 50 nm to 200 nm. For example, vapor deposition may be use to form the film.

When producing a bottom emission type organic EL element, the upper electrode 306 of the organic EL element 1 may be configured to have optical reflectivity. Thereby, the upper electrode 306 can reflect in the display side direction light generated by the organic EL element A and traveled toward the upper side as the opposite direction to the display side. Since the reflected light is also utilized for a display purpose, the emission efficiency of the organic EL element can be improved.

[Method of Manufacturing Display Element, Optical Element, or Illumination Element]

Another aspect of the present disclosure relates to a method of manufacturing a display element, an optical element, or an illumination element. In one or a plurality of embodiments, the production method according to the present disclosure is a method of manufacturing the display element, the optical element, or the illumination element according to the present disclosure. Further, in one or a plurality of embodiments, the manufacturing method according to the present disclosure is a method of manufacturing a display element, an optical element, or an illumination element, which includes the steps of applying the polyamide resin composition according to the present disclosure onto a base; forming a polyamide film after the application step; and forming the display element, the optical element, or the illumination element on a surface of the polyamide film not in contact with the base. The production method according to the present disclosure may further include the step of de-bonding, from the base, the display element, the optical element, or the illumination element formed on the base.

<Non-Limiting Embodiment of Method of Producing Organic EL Element>

As one embodiment of the method of manufacturing a display element according to the present disclosure, hereinafter, one embodiment of a method of manufacturing an organic EL element will be described with reference to the drawing.

A method of producing the organic EL element 1 shown in FIG. 4 includes a fixing step, a gas barrier layer production step, a thin film transistor production step, an organic EL layer production step, a sealing step and a de-bonding step. Hereinafter, each step will be described in detail.

1. Fixing Step

In the fixing step, the transparent resin substrate 100 is fixed onto the base 500. A way to fix the transparent resin substrate to the base is not particularly limited. For example, an adhesive may be applied between the base 500 and the transparent substrate, or a part of the transparent resin substrate 100 may be fused and attached to the base 500 to fix the transparent resin substrate 100 to the base 500. Further, as the material of the base, glass, metal, silicon, resin or the like is used, for example. These materials may be used alone or in combination of two or more as appropriate. Furthermore, the transparent resin substrate 100 may be attached to the base 500 by applying a releasing agent or the like onto the base 500 and placing the transparent resin substrate 100 on the applied releasing agent. In one or a plurality of embodiments, the polyamide film 100 is formed by applying the polyamide resin composition according to the present disclosure onto the base 500, and drying the applied polyamide resin composition.

2. Gas Barrier Layer Production Step

In the gas barrier layer production step, the gas barrier layer 101 is produced on the transparent resin substrate 100. A way to produce the gas barrier layer 101 is not particularly limited, and a known method can be used.

3. Thin Film Transistor Production Step

In the thin film transistor production step, the thin film transistor B is produced on the gas barrier layer. A way to produce the thin film transistor B is not particularly limited, and a known method can be used.

4. Organic EL Layer Production Step

The organic EL layer production step includes a first step and a second step. In the first step, the flattened layer 301 is formed. The flattened layer 301 can be formed by, for example, spin-coating, slit-coating, or ink-jetting a photosensitive transparent resin. At that time, an opening needs to be formed in the flattened layer 301 so that the connector 300 can be formed in the second step. Generally, the flattened layer has a film thickness of, but is not limited to, about 100 nm to 2 μm.

In the second step, first, the connector 300 and the lower electrode 302 are formed at the same time. Sputtering, vapor deposition, ion plating or the like may be used to form the connector 300 and the lower electrode 302. Generally, each of these electrodes has a film thickness of, but is not limited to, about 50 nm to 200 nm. Subsequently, the hole transport layer 303, the light-emitting layer 304, the electron transport layer 305, and the upper electrode 306 as the cathode of the organic EL element 1 are formed. To form these components, a method such as vapor deposition, application, or the like can be used as appropriate in accordance with the materials to be used and the laminate structure. Further, irrespective of the explanations given in this example, other layers may be chosen from known organic layers such as a hole injection layer, an electron transport layer, a hole blocking layer and an electron blocking layer as needed and be used to configuring the organic layers of the organic EL element 1.

5. Sealing Step

In the sealing step, the organic EL layer C is sealed with the sealing member 307 from top of the upper electrode 306. For example, a glass material, a resin material, a ceramics material, a metal material, a metal compound or a composite thereof can be used to form the sealing member 307, and a material best suited to the sealing member 307 can be chosen as appropriate.

6. De-Bonding Step

In the de-bonding step, the produced organic EL element 1 is de-bonded from the base 500. To implement the de-bonding step, for example, the organic EL element 1 may be physically stripped from the base 500. At that time, the base 500 may be provided with a de-bonding layer, or a wire may be inserted between the base 500 and the display element to remove the organic EL element. Further, examples of other methods of de-bonding the organic EL element 1 from the base 500 include the following: forming a de-bonding layer on the base 500 except at ends, and cutting, after the production of the element, the inner part from the ends to remove the element from the base; providing a layer of silicon or the like between the base 500 and the element, and irradiating the silicon layer with a laser to strip the element; applying heat to the base 500 to separate the base 500 and the transparent substrate from each other; and removing the base 500 using a solvent. These methods may be used alone or any of these methods may be used in combination of two or more. Especially in one or a plurality of embodiments, the strength of adhesion between the polyamide film and the base can be controlled by a silane coupling agent, so that the organic EL element 1 can be physically stripped without using the complicated method such as described above.

In one or more embodiments, the organic EL element obtained by the method of producing a display, optical or illumination element according to the present embodiment has excellent characteristics such as excellent transparency and heat-resistance, low linear expansivity and low optical anisotropy.

[Display Device, Optical Device, and Illumination Device]

An aspect of the present disclosure relates to a display device, an optical device, or an illumination device using the display element, the optical element, or the illumination element according to the present disclosure, or a method of manufacturing the display device, the optical device, or the illumination device. Examples of the display device include, but are not limited to, an imaging element; examples of the optical device include, but are not limited to, a photoelectric complex circuit; and examples of the illumination device include, but are not limited to, a TFT-LCD and OEL illumination.

[Method for Manufacturing Sensor Element]

In another aspect, the present disclosure relates to a method for manufacturing a sensor element, including steps (A) and (B) below:

(A) applying a polyamide solution according to the present disclosure onto a base so as to form a polyamide film on the base;

(B) forming the sensor element on the surface of the polyamide film.

For the base, the above-mentioned base can be used.

In the step (A) of the manufacturing method in this aspect, a laminated composite material can be formed. In one or a plurality of embodiments, the step (A) of the manufacturing method in this aspect includes steps (i) and (ii) below:

(i) applying the above-mentioned polyamide solution onto a base (see FIG. 1, step A);

(ii) heating the applied polyamide solution after the step (i) so as to form a polyamide film (see FIG. 1, step B).

The application in the step (i) and the heating temperature in the step (ii) may be set as mentioned above. The manufacturing method in this aspect may include, following the step (ii), a curing step (iii) to cure the polyamide film. The temperature and the time period for the curing can be set as mentioned above.

The formation of the sensor element in the step (B) of the manufacturing method in this aspect is not limited in particular, but it can be carried out appropriately for the sensor element for manufacturing an element that has been or will be manufactured.

In one or a plurality of embodiments, the manufacturing method in this aspect includes, following the step (B), a step (C) for de-bonding a formed sensor element from a glass plate. In the de-bonding step (C), the produced sensor element is de-bonded from a base. The de-bonding step can be carried out as mentioned above.

[Sensor Element]

In the present disclosure, “sensor element” refers to a sensor element that can be used in an input device. In one or a plurality of non-limiting embodiments, examples of the “sensor element” include a sensor element having a polyamide film form from a polyamide solution of the present disclosure. In one or a plurality of embodiments, examples of a “sensor element” of the present disclosure include a sensor element that is formed on the surface of the polyamide film formed on a base. In one or a plurality of embodiments, the sensor element can be de-bonded from the base. In one or a plurality of non-limiting embodiments, examples of the “sensor element” include a sensor element for electromagnetic wave, a sensor element for magnetic field, a sensor element for capacitance change or a sensor element for pressure, examples of which include an image pickup element, a radiation sensor element, a photo sensor element, a magnetic sensor element, a capacitive sensor element, a touch sensor element, or a pressure sensor element. In one or a plurality of embodiments, examples of the radiation sensor element include an X-ray sensor element. In one or a plurality of embodiments, the sensor element according to the present disclosure includes a sensor element that is manufactured by using the polyamide solution according to the present disclosure, and/or a sensor element that is manufactured by using the laminated composite material according to the present disclosure, and/or a sensor element that is manufactured by the process for manufacturing an element according to the present disclosure. Further, in one or a plurality of embodiments, forming of the sensor element according to the present disclosure includes forming of a photoelectric conversion element and a driver element.

[Input Device]

In the present disclosure, in one or a plurality of embodiments, examples of an input device using the “sensor element” include an optical input device, an image pickup input device, a magnetic input device, a capacitive input device and a pressure input device. In one or a plurality of non-limiting embodiments, examples of the input device include a radiation image pickup device, a visible light image pickup device, a magnetic sensor device touch panel, fingerprint authentication panel, light emitting material using piezoelectric device. In one or a plurality of embodiments, examples of the radiation image pickup device include an X-ray pickup device. Further, in one or a plurality of non-limiting embodiments, an input device according to the present disclosure may have a function of an output device such as display function. Therefore, in one aspect, the present disclosure relates to an input device using a sensor element manufactured by the manufacturing method in this aspect, and also relates to a method for manufacturing the same.

<Non-Limiting Embodiment for Sensor Element>

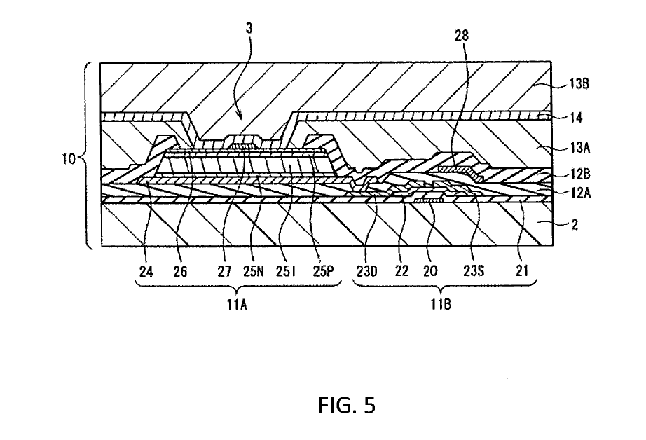

Hereinafter, an embodiment of sensor element that can be manufactured by the manufacturing method in this aspect are explained with reference to FIG. 5.

FIG. 5 is a schematic cross-sectional view showing a sensor element 1 according to an embodiment. The sensor element 1 has a plurality of pixels. This sensor element 1 is produced by forming, on a surface of a substrate 2, a pixel circuit including a plurality of photodiodes 11A (photoelectric conversion element) and a thin film transistor (TFT) 11B as the driver element for the photodiodes 11A. This substrate 2 is the polyamide film to be formed on a base (not shown) by the step (A) of the manufacturing method in this aspect. And in the step (B) of the manufacturing method in this aspect, the photodiodes 11A (photoelectric conversion element) and the thin film transistor 11B as the driver element for the photodiodes 11A are formed.

A gate insulating film 21 is provided on the substrate 2, and it is composed of a single layer film of any one of a silicon oxide (SiO₂) film, a silicon oxynitride (SiON) film and a silicon nitride (SiN) film for example, or two or more of them. A first interlayer insulating film 12A is provided on the gate insulating film 21, and it is composed of a silicon oxide film or a silicon nitride film etc. This first interlayer insulating film 12A functions also as a protective film (passivation film) to cover the top of the thin film transistor 11B described below.

(Photodiode 11A)

The photodiode 11A is disposed on a selective region of the substrate 2 via the gate insulating film 21 and the first interlayer insulating film 12A. Specifically, the photodiode 11A is prepared by laminating, on the first interlayer insulating film 12A, a lower electrode 24, a n-type semiconductor layer 25N, an i-type semiconductor layer 251, a p-type semiconductor layer 25P and an upper electrode 26 in this order. The upper electrode 26 is an electrode for supplying a reference potential (bias potential) during a photoelectric conversion for example to the above-mentioned photoelectric conversion layer, and thus it is connected to a wiring layer 27 as a power supply wiring for supplying the reference potential. This upper electrode 26 is composed of a transparent conductive film of ITO (indium tin oxide) or the like, for example.

(Thin Film Transistor 11B)

The thin film transistor 11B is composed of a field effect transistor (FET), for example. This thin film transistor 11B is prepared by forming on the substrate 2 a gate electrode 20 composed of titanium (Ti), Al, Mo, tungsten (W), chromium (Cr) and the like, and by forming the above-mentioned gate insulating film 21 on this gate electrode 20. Further, a semiconductor layer 22 is formed on the gate insulating film 21, and the semiconductor layer 22 has a channel region. On this semiconductor layer 22, a source electrode 23S and a drain electrode 23D are formed. Specifically, here, the drain electrode 23D is connected to the lower electrode 24 in each photodiode 11A while the source electrode 23S is connected to a relay electrode 28.

Furthermore in the sensor element 1, on such photodiode 11A and the thin film transistor 11B, a second interlayer insulating film 12B, a first flattened film 13A, a protective film 14 and a second flattened film 13B are provided in this order. Further in this first flattened film 13A, an opening 3 is formed corresponding to the region for forming the photodiode 11A.

On the sensor element 1, for example, a wavelength conversion member is formed to produce a radiograph device.

The present disclosure can relate to the following one or a plurality of embodiments.

<1> A polyamide solution comprising an aromatic polyamide and a solvent,

wherein the aromatic polyamide comprises a constitutional unit having one or more free carboxyl groups and has an aromatic ring structure and an alicyclic structure in the main chain.

<2> The polyamide solution according to <1>, wherein a cast film with a thickness of 9 to 12 μm formed by applying the solution onto a glass plate has yellowness (JIS K7373) of 2.4 or less.
<3> The solution according to <1> or <2>, wherein monomer components cap able of introducing an alicyclic structure into the main chain account for 4 mole % or more and 50 mole % or less of the total amount of monomer components used for synthesis of the polyamide.
<4> The solution according to any one of <1> to <4>, wherein monomer components having a free carboxyl group account for 0.01 mole % or more and 30 mole % or less of the total amount of monomer components used for synthesis of the polyamide.

<5> The solution according to any one of <1> to <5>, wherein the polyamide comprises an aromatic polyamide having any of the constitutional units of the general formulas (I) to (IV):

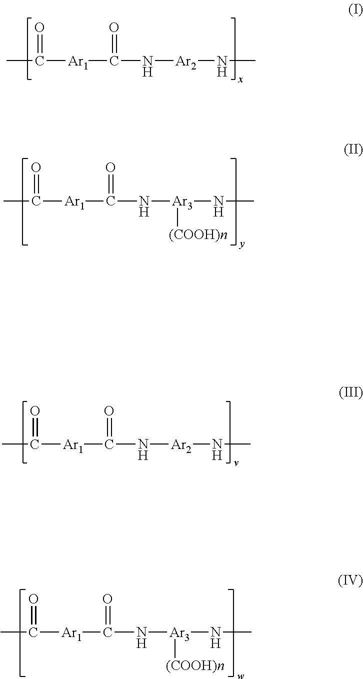

wherein x represents mole % of the constitutional unit (I), y represents mole % of the constitutional unit (II), v represents mole % of the constitutional unit (III), and w represents mole % of the constitutional unit (IV),

wherein x+v is 70 to 99.99 mole %;

wherein y+w is 30 to 0.01 mole %;

wherein x+y is 96 to 50 mole %;

wherein v+w is 4 to 50 mole %;

wherein n=1 to 4;

wherein Ar₁ is selected from the group comprising:

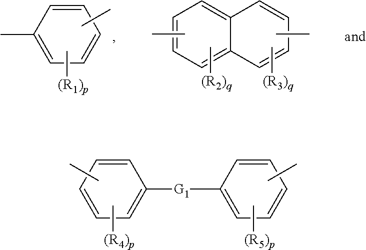

wherein p=4, q=3, and wherein R₁, R₂, R₃, R₄, R₅ are selected from the group comprising hydrogen, halogen, alkyl, substituted alkyl nitro, cyano, thioalkyl, alkoxy, substituted alkoxy, substituted aryl, alkyl ester and substituted alkyl ester, and combinations thereof, wherein G₁ is selected from a group comprising a covalent bond; a CH₂ group; a C(CH₃)₂ group; a C(CF₃)₂ group; a C(CX₃)₂ group, wherein X is a halogen; a CO group; an O atom; a S atom; a SO₂ group; a Si(CH₃)₂ group; 9,9-fluorene group; substituted 9,9-fluorene group; and an OZO group, wherein Z is an aryl group or substituted aryl group;

wherein A₁ is selected from the group comprising:

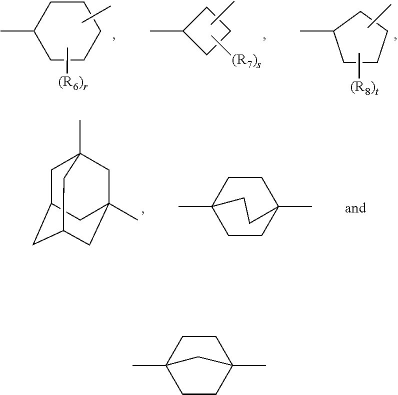

wherein r=10, s=6, t=8 and wherein R₆, R₇, R₈ are selected from the group comprising hydrogen, halogen, alkyl, substituted alkyl, nitro, cyano, thioalkyl, alkoxy, substituted alkoxy, aryl, substituted aryl, alkyl ester and substituted alkyl ester, and combinations thereof,

wherein Ar₂ is selected from the group of comprising:

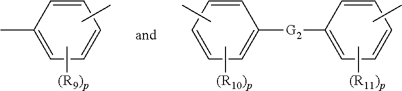

wherein p=4, wherein R₉, R₁₀, R₁₁ are selected from the group comprising hydrogen, halogen, alkyl, substituted alkyl, nitro, cyano, thioalkyl, alkoxy, substituted alkoxy, aryl, substituted aryl, alkyl ester, and substituted alkyl ester, and combinations thereof, wherein G₂ is selected from a group comprising a covalent bond; a CH₂ group; a C(CH₃)₂ group; a C(CF₃)₂ group; a C(CX₃)₂ group, wherein X is a halogen; a CO group; an O atom; a S atom; a SO₂ group; a Si(CH₃)₂ group; 9,9-fluorene group; substituted 9,9-fluorene group; and an OZO group, w herein Z is an aryl group or substituted aryl group;

wherein Ar₃ is selected from the group comprising:

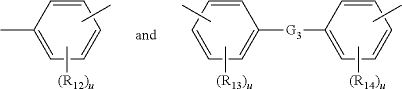

wherein u=0 to 3, wherein R₁₂, R₁₃, R₁₄ are selected from the group comprising hydrogen, halogen, alkyl, substituted alkyl, nitro, cyano, thioalkyl, alkoxy, substituted alkoxy, aryl, substituted aryl, alkyl ester, and substituted alkyl ester and combinations thereof, wherein G₃ is selected from a group comprising a covalent bond; a CH₂ group; a C(CH₃)₂ group; a C(CF₃)₂ group; a C(CX₃)₂ group, wherein X is a halogen; a CO group; an O atom; a S atom; a SO₂ group; a Si(CH₃)₂ group; 9,9-fluorene group; substituted 9,9-fluorene group; and an OZO group, wherein Z is an aryl group or substituted aryl group.

<6> The solution according to <5>, wherein the polyamide contains multiple constitutional units of the general formulas (I) and (II), and wherein Ar₁, Ar₂ and Ar₃ are the same or different.
<7> The solution according to <5> or <6>, wherein the polyamide contains multiple constitutional units of the general formulas (III) and (IV), and wherein A₁, Ar₂, and Ar₃ are the same or different.
<8> The solution according to any one of <1> to <7>, wherein the polyamide is obtained by polymerizing one or more diacid dichlorides selected from the group comprising:

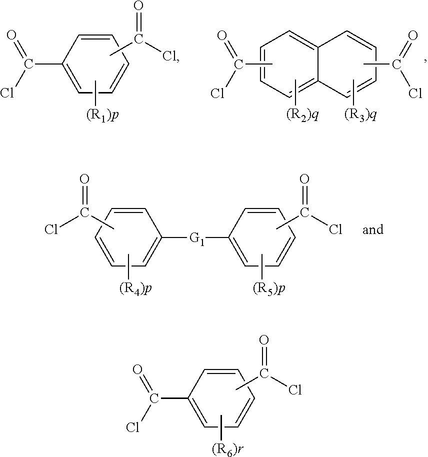

wherein p=4, q=3, r=10 and wherein R₁, R₂, R₃, R₄, R₅, R₆ are selected from the group comprising hydrogen, halogen, alkyl, substituted alkyl, nitro, cyano, thioalkyl, alkoxy, substituted alkoxy, aryl, substituted aryl, alkyl ester and substituted alkyl ester and combinations thereof, wherein G₁ is selected from a group comprising a covalent bond; a CH₂ group; a C(CH₃)₂ group; a C(CF₃)₂ group; a C(CX₃)₂ group, wherein X is a halogen; a CO group; an O atom; a S atom; a SO₂ group; a Si(CH₃)₂ group; 9,9-fluorene group; substituted 9,9-fluorene group; and an OZO group, wherein Z is an aryl group or substituted aryl group.

<9> The solution according to any one of <1> to <8> wherein the polyamide is obtained by polymerizing one or more aromatic diamines selected from the group comprising;

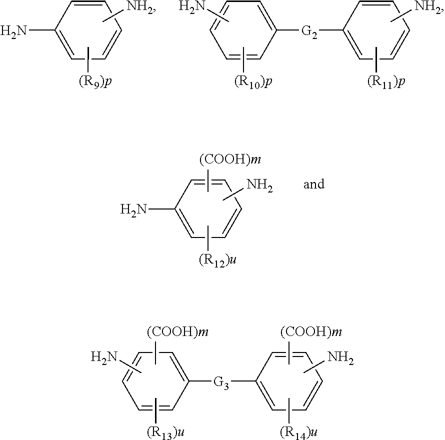

wherein p=4, m=1 to 4, and u=4 to 3, wherein R₉, R₁₀, R₁₁, R₁₂, R₁₃, R₁₄ are selected from the group comprising hydrogen, halogen, alkyl, substituted alkyl, nitro, cyano, thioalkyl, alkoxy, substituted alkoxy, aryl, substituted aryl, alkyl ester, and substituted alkyl ester and combinations thereof, wherein G₂ and G₃ are selected from a group comprising a covalent bond; a CH₂ group; a C(CH₃)₂ group; a C(CF₃)₂ group; a C(CX₃)₂ group, wherein X is a halogen; a CO group; an O atom; a S atom; a SO₂ group; a Si(CH₃)₂ group; 9,9-fluorene group; substituted 9,9-fluorene group; and an OZO group, wherein Z is an aryl group or substituted aryl group.

<10> The solution according to any one of <1> to <9>, wherein at least one of terminals of the polyamide is end-capped.
<11> The solution according to any one of <1> to <10>, for use in the process for manufacturing a display element, an optical element, an illumination element or a sensor element comprising the steps of

a) applying a solution of an aromatic copolyamide onto a base;

b) forming a polyamide film on the base after the applying step (a); and

c) forming the display element, the optical element, the illumination element or the sensor element on the surface of polyamide film,

wherein the base or the surface of the base is composed of glass or silicon wafer.

<12> A process for manufacturing a display element, an optical element, an illumination element or a sensor element, comprising the steps of

a) applying the solution according to any one of <1> to <12> onto a base;

b) forming a polyamide film on the base after the applying step (a); and

c) forming the display element, the optical element, the illumination element, or the sensor element on the surface of polyamide film,

wherein the base or the surface of the base is composed of glass or silicon wafer.

<13> The process according to <12>, further comprising the step of

de-bonding, from the base, the display element, the optical element, the illumination element or the sensor element formed on the base.

<14> A laminated composite material, comprising a glass plate and a polyamide resin layer;

wherein the polyamide resin layer is laminated onto one surface of the glass plate;

wherein the polyamide resin layer has yellowness (JIS K7373) of 2.4 or less; and

wherein the polyamide resin layer is obtained by applying the solution according to any one of <1> to <11> onto the glass plate.

<15> The laminated composite material according to <14>, wherein the thickness of the glass plate is 0.3 mm or more.
<16> The laminated composite material according to <14> or <15> wherein the thickness of the polyamide resin is 500 μm or less.
<17> A process for manufacturing a display element, an optical element, an illumination element or a sensor element, comprising the step of forming the display element, the optical element, the illumination element or the sensor element on a surface of the polyamide resin layer of the laminated composite material according to any one of <14> to <16>, wherein the surface is not opposed to the glass plate.
<18> The process according to <17>, further comprising the step of de-bonding, from the glass plate, the display element, the optical element, the illumination element or the sensor element formed on the glass plate.

### Example

Polyamide solutions (Example 1 to 5 and Comparative example 1 to 2) were prepared using components as described in Table 1 as well as bellow. The polyamide solutions were casted on a glass substrate to form films, and the properties (Thickness, haze, total light transmittance (Tt) and Yellowness (Yellow Index)) of each film were measured in the following manners. Note that 99% of the used HTPC was trans-form.

[Aromatic Diacid Dichloride]

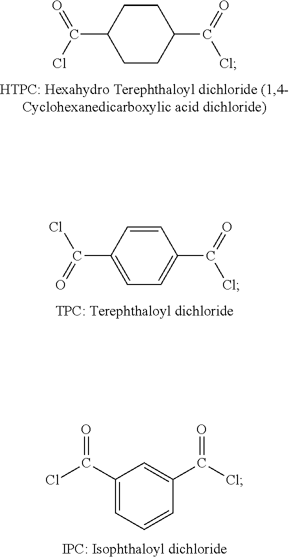 [SMILES: O=C(Cl)C1CCC(C(=O)Cl)CC1 ; O=C(Cl)c1ccc(C(=O)Cl)cc1 ; O=C(Cl)c1cccc(C(=O)Cl)c1]

[Aromatic Diamine]

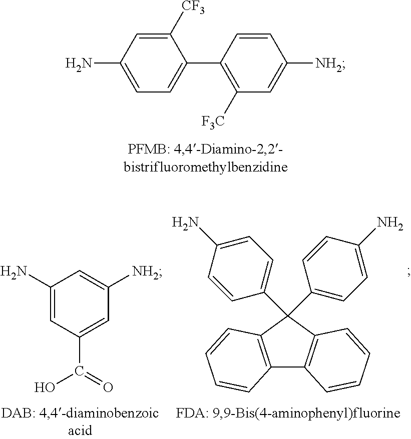 [SMILES: Nc1ccc(-c2ccc(N)cc2C(F)(F)F)c(C(F)(F)F)c1 ; Nc1cc(N)cc(C(=O)O)c1 ; Nc1ccc(C2(c3ccc(N)cc3)c3ccccc3-c3ccccc32)cc1]

[Solvent]

DMAc: N,N-dimethylacetamide

[Trapping Reagent]

Propylene Oxide

[Preparation of Polyamide Solution]

This example illustrates the general procedure for the preparation of the polyamide solution of Example 1 containing 5% by weight of a copolymer of TPC, HTPC, FDA, PFMB and DAB (75%/25%/30%/65%/5% mol ratio) in DMAc.

To a 1000 ml three necked round bottom flask, equipped with a mechanical stirrer, a nitrogen inlet and outlet, are added FDA (6272 g, 0.918 mol), PFMB (12.489 g, 0.039 mol), DAB (0.456 g, 0.003 mol) and DMAc (500 ml). After the FDA, the PFMB and the DAB dissolved completely, PrO (10.454 g, 0.180 mol) was added to the solution. The solution is cooled to 0° C. After the addition, under stirring, TPC (8.770 g, 0.0432 mol) and HTPC (3.136 g, 0.015 mol) were added to the solution, and the flask inner wall was washed with DMAc (4 ml). After two hours, benzoyl chloride (0.446 g, 3.173 mmol) was added to the solution and stirred for another two hours, thereby the polyamide solution of Example 1 was obtained.

Similarly to example 1, the polyamide solutions of Example 2 to 5 and Comparative example 1 to 2 were prepared as 5 wt % polyamide solutions.

[Formation of Polyamide Films]

The polyamide solutions of Example 1 to 5 and Comparative example 1 to 2 prepared were casted on a glass substrate to form films, and the properties of each film were studied.

Each polyamide solution was applied onto a flat glass substrate (10 cm×10 cm, trade name: EAGLE XG from Corning Inc., USA) by spin coating. After drying the casted solution for 30 minutes or more at 60° C., the temperature was increased from 60° C. to 330° C. or 350° C., and the temperature was kept at 350° C. for 30 minutes under vacuum or in an inert atmosphere to cure the film. The polyamide films of Example 1 to 5 and Comparative example 1 to 2 obtained each had a thickness of about 10 μm.

The properties of the polyamide films (thickness, haze, total light transmittance (Tt), yellowness) were measured in the below-described manners. Table 1 provides the results.

[Thickness]

The thickness of each polyamide film was measured using a contact digital sensor (GT2 Series, from KEYENCE CORPORATION).

[Haze]

The haze of each polyamide film in a D line (sodium line) was measured using a haze meter (NDH-2000, from Nippon Denshoku Industries Co., Ltd.).

[Total Light Transmittance at 365 nm]

The total light transmittance (Tt) at 365 nm of Each polyamide film was measured using a spectrophotometer (N-670, from JASCO Co.).

[Yellow Index]

The yellowness of each polyamide film was measured according to JIS K7373. Simply, the yellowness was calculated by analysis software after measurement of Tt using a spectrophotometer (N-670, from JASCO Co.).

TABLE 1

| | Composition of Polyamide | | | | | | | | | Light | |
|---|---|---|---|---|---|---|---|---|---|---|---|
| | Diacid | | | | | | | | | Transmission | Yellow Index |
| | dichloride | | | Diamine | | | Cure Temp. (C.)/ | Thickness | Haze | at 400 nm | by |
| | TPC | IPC | HTPC | FDA | PFMB | DAB | Time (min) | (um) | (%) | (%) | JIS K 7373 |
| Example 1 | 75 | | 25 | 30 | 65 | 5 | 350/30 | 9.8 | 0.1 | 79.0 | 2.1 |
| Example 2 | 50 | | 50 | 30 | 65 | 5 | 350/30 | 9.5 | 0.1 | 82.0 | 1.7 |
| Example 3 | 10 | 80 | 10 | | 95 | 5 | 350/30 | 9.5 | 0.1 | 83.2 | 2.0 |
| Example 4 | 10 | 60 | 30 | | 95 | 5 | 350/30 | 9.5 | 0.1 | 84.1 | 1.9 |
| Example 5 | 10 | 30 | 60 | | 95 | 5 | 350/30 | 9.9 | 0.2 | 85.6 | 1.6 |
| Com. Ex. 1 | 100 | | | 30 | 65 | 5 | 350/30 | 9.5 | 0.1 | 76.8 | 2.5 |
| Com. Ex. 2 | 10 | 90 | | | 95 | 5 | 350/30 | 10.7 | 0.2 | 80.6 | 2.7 |

As shown in Table 1, the yellowness of the polyamide films of Example 1 to 5 were suppressed compared with that of Comparative example 1 to 2.

The embodiments have been described, hereinabove. It will be apparent to those skilled in the art that the above methods and apparatuses may incorporate changes and modifications without departing from the general scope of the present disclosure. It is intended to include all such modifications and alterations insofar as they come within the scope of the appended claims or the equivalents thereof. Although the description above contains much specificity, this should not be construed as limiting the scope of the disclosure, but as merely providing illustrations of some of the embodiments of the present disclosure. Various other embodiments and ramifications are possible within its scope.

Furthermore, notwithstanding that the numerical ranges and parameters setting forth the broad scope of the disclosure are approximations, the numerical values set forth in the specific examples are reported as precisely as possible. Any numerical value, however, inherently contain certain errors necessarily resulting from the standard deviation found in their respective testing measurements.

What is claimed is:

1. A polyamide solution comprising an aromatic polyamide and a solvent,
wherein the aromatic polyamide comprises a constitutional unit having one or more free carboxyl groups and has an aromatic ring structure and an alicyclic structure in the main chain.

2. The polyamide solution according to claim 1, wherein a cast film with a thickness of 9 to 12 μm formed by applying the solution onto a glass plate has yellowness (JIS K7373) of 2.4 or less.

3. The solution according to claim 1, wherein monomer components capable of introducing an alicyclic structure into the main chain account for 4 mole % or more and 50 mole % or less of the total amount of monomer components used for synthesis of the polyamide.

4. The solution according to claim 1, wherein monomer components having a free carboxyl group account for 0.01 mole % or more and 30 mole % or less of the total amount of monomer components used for synthesis of the polyamide.

5. The solution according to claim 1, wherein the polyamide comprises an aromatic polyamide having any of the constitutional units of the general formulas (I) to (IV): 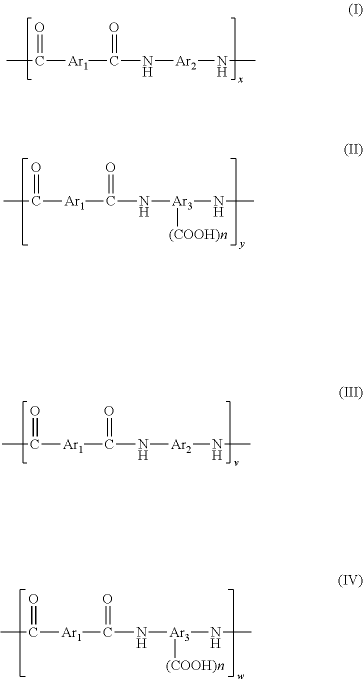
wherein x represents mole % of the constitutional unit (I), y represents mole % of the constitutional unit (II), v represents mole % of the constitutional unit (III), and w represents mole % of the constitutional unit (IV),
wherein x+v is 70 to 99.99 mole %;
wherein y+w is 30 to 0.01 mole %;
wherein x+y is 96 to 50 mole %;
wherein v+w is 4 to 50 mole %;
wherein n=1 to 4;
wherein Ar₁ is selected from the group comprising: 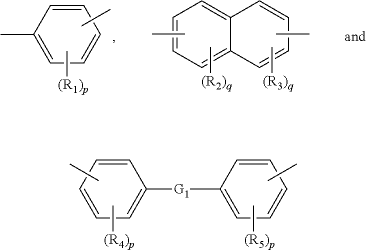
wherein p=4, q=3, and wherein R₁, R₂, R₃, R₄, R₅ are selected from the group comprising hydrogen, halogen, alkyl, substituted alkyl nitro, cyano, thioalkyl, alkoxy, substituted alkoxy, substituted aryl, alkyl ester and substituted alkyl ester, and combinations thereof, wherein G₁ is selected from a group comprising a covalent bond; a CH₂ group; a C(CH₃)₂ group; a C(CF₃)₂ group; a C(CX₃)₂ group, wherein X is a halogen; a CO group; an O atom; a S atom; a SO₂ group; a Si(CH₃)₂ group; 9,9-fluorene group; substituted 9,9-fluorene group; and an OZO group, wherein Z is an aryl group or substituted aryl group;
wherein A₁ is selected from the group comprising: 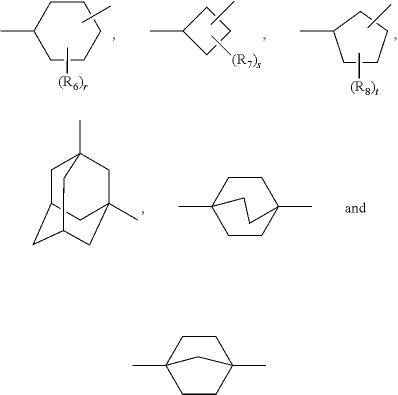
wherein r=10, s=6, t=8 and wherein R₆, R₇, R₈ are selected from the group comprising hydrogen, halogen, alkyl, substituted alkyl, nitro, cyano, thioalkyl, alkoxy, substituted alkoxy, aryl, substituted aryl, alkyl ester and substituted alkyl ester and combinations thereof,
wherein Ar₂ is selected from the group of comprising: 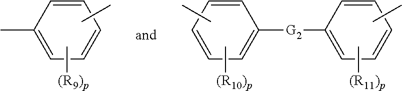
wherein p=4, wherein R₉, R₁₀, R₁₁ are selected from the group comprising hydrogen, halogen, alkyl, substituted alkyl, nitro, cyano, thioalkyl, alkoxy, substituted alkoxy, aryl, substituted aryl, alkyl ester, and substituted alkyl ester, and combinations thereof, wherein G₂ is selected from a group comprising a covalent bond; a CH₂ group; a C(CH₃)₂ group; a C(CF₃)₂ group; a C(CX₃)₂ group, wherein X is a halogen; a CO group; an O atom; a S atom; a SO₂ group; a Si(CH₃)₂ group; 9,9-fluorene group; substituted 9,9-fluorene group; and an OZO group, wherein Z is an aryl group or substituted aryl group;
wherein Ar₃ is selected from the group comprising: 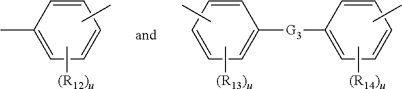
wherein u=0 to 3, wherein R₁₂, R₁₃, R₁₄ are selected from the group comprising hydrogen, halogen, alkyl, substituted alkyl, nitro, cyano, thioalkyl, alkoxy, substituted alkoxy, aryl, substituted aryl, alkyl ester, and substituted alkyl ester, and combinations thereof, wherein G₃ is selected from a group comprising a covalent bond; a CH₂ group; a C(CH₃)₂ group; a C(CF₃)₂ group; a C(CX₃)₂ group, wherein X is a halogen; a CO group; an O atom; a S atom; a SO₂ group; a Si(CH₃)₂ group; 9,9-fluorene group; substituted 9,9-fluorene group; and an OZO group, wherein Z is an aryl group or substituted aryl group.

6. The solution according to claim 5, wherein the polyamide contains multiple constitutional units of the general formulas (I) and (II), and wherein Ar₁, Ar₂ and Ar₃ are the same or different.

7. The solution according to claim 1, wherein the polyamide contains multiple constitutional units of the general formulas (III) and (IV), and wherein A₁, Ar₂, and Ar₃ are the same or different.

8. The solution according to claim 1, wherein the polyamide is obtained by polymerizing one or more diacid dichlorides selected from the group comprising: 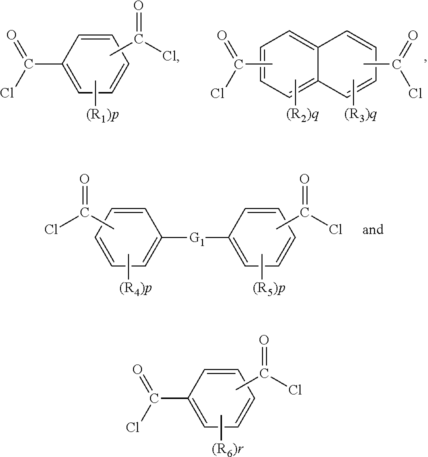
wherein p=4, q=3, r=10 and wherein R₁, R₂, R₃, R₄, R₅, R₆ are selected from the group comprising hydrogen, halogen, alkyl, substituted alkyl, nitro, cyano, thioalkyl, alkoxy, substituted alkoxy, aryl, substituted aryl, alkyl ester and substituted alkyl ester, and combinations thereof, wherein G₁ is selected from a group comprising a covalent bond; a CH₂ group; a C(CH₃)₂ group; a C(CF₃)₂ group; a C(CX₃)₂ group, wherein X is a halogen; a CO group; an O atom; a S atom; a SO₂ group; a Si(CH₃)₂ group; 9,9-fluorene group; substituted 9,9-fluorene group; and an OZO group, wherein Z is an aryl group or substituted aryl group.

9. The solution according to claim 1, wherein the polyamide is obtained by polymerizing one or more aromatic diamines selected from the group comprising: 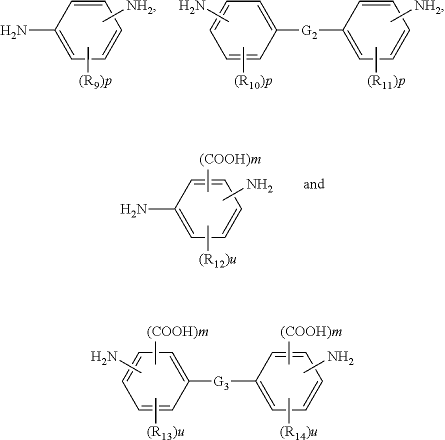
wherein p=4, m=1 to 4, and u=0 to 3, wherein R₉, R₁₀, R₁₁, R₁₂, R₁₃, R₁₄ are selected from the group comprising hydrogen, halogen, alkyl, substituted alkyl, nitro, cyano, thioalkyl, alkoxy, substituted alkoxy, aryl, substituted aryl, alkyl ester, and substituted alkyl ester, and combinations thereof, wherein G₂ and G₃ are selected from a group comprising a covalent bond; a CH₂ group; a C(CH₃)₂ group; a C(CF₃)₂ group; a C(CX₃)₂ group, wherein X is a halogen; a CO group; an O atom; a S atom; a SO₂ group; a Si(CH₃)₂ group; 9,9-fluorene group; substituted 9,9-fluorene group; and an OZO group, wherein Z is an aryl group or substituted aryl group.

10. The solution according to claim 1, wherein at least one of terminals of the polyamide is end-capped.

11. The solution according to claim 1, for use in the process for manufacturing a display element, an optical element, an illumination element or a sensor element comprising the steps of:
a) applying a solution of an aromatic copolyamide onto a base;
b) forming a polyamide film on the base after the applying step (a); and
c) forming the display element, the optical element, the illumination element or the sensor element on the surface of polyamide film,
wherein the base or the surface of the base is composed of glass or silicon wafer.

12. A process for manufacturing a display element, an optical element, an illumination element or a sensor element, comprising the steps of:
a) applying the solution according to claim 1 onto a base;
b) forming a polyamide film on the base after the applying step (a); and
c) forming the display element, the optical element, the illumination element, or the sensor element on the surface of polyamide film,
wherein the base or the surface of the base is composed of glass or silicon wafer.

13. The process according to claim 12, further comprising the step of
de-bonding, from the base, the display element, the optical element, the illumination element or the sensor element formed on the base.

14. A laminated composite material, comprising a glass plate and a polyamide resin layer;
wherein the polyamide resin layer is laminated onto one surface of the glass plate;
wherein the polyamide resin layer has yellowness (JIS K7373) of 2.4 or less; and
wherein the polyamide resin layer is obtained by applying the solution according to claim 1 onto the glass plate.

15. The laminated composite material according to claim 14, wherein the thickness of the glass plate is 0.3 mm or more.

16. The laminated composite material according to claim 14, wherein the thickness of the polyamide resin is 500 μm or less.

17. A process for manufacturing a display element, an optical element, an illumination element or a sensor element, comprising the step of forming the display element, the optical element, the illumination element or the sensor element on a surface of the polyamide resin layer of the laminated composite material according to claim 14, wherein the surface is not opposed to the glass plate.

18. The process according to claim 17, further comprising the step of
de-bonding, from the glass plate, the display element, the optical element, the illumination element or the sensor element formed on the glass plate.
